(19) United States
(12) Patent Application Publication
(10) Pub. No.: US 2009/0274343 A1
(43) Pub. Date: Nov. 5, 2009

(54) Dynamic optimization of a biometric sensor

(75) Inventor: David Brian Clarke, Melbourne, FL (US)

Correspondence Address: STERNE, KESSLER, GOLDSTEIN & FOX P.L.L.C., 1100 NEW YORK AVENUE, N.W., WASHINGTON, DC, 20005, US

(73) Assignee: Sonavation, Inc., Palm Beach Gardens, FL (US)

(21) Appl. No.: 12/149,608

(22) Filed: May 5, 2008

(51) Int. Cl. G06K 9/00

(52) U.S. Cl. 382/115; 382/124

(57) ABSTRACT

Provided is a method for dynamic optimization of a biometric sensor. The method includes receiving image data having pixel values. The pixel values are processed to determine a bias. An offset adjustment is determined to mitigate the bias. The biometric sensor is adjusted with the offset adjustment.

### BACKGROUND OF THE INVENTION

1. Field of the Invention

The present invention relates to biometric sensor optimization. More particularly, the present invention relates to optimizing performance of a biometric sensor.

2. Related Art

In the field of biometric image analysis, traditional techniques sample an image, such as a fingerprint, as the image is sensed by a sensing mechanism. This sensing mechanism, such as a pressure-sensitive piezoelectric fingerprint sensor, captures images of the fingerprint. Ridges and valleys of the fingerprint vary pressure on different parts of the piezoelectric sensor to form light and dark portions of the captured image.

The sensing ability of conventional biometric sensors, and their processing circuits, suffers from many shortcomings due to effects of changing environmental conditions, sensor manufacturing variations, and conditions of the fingers themselves. These conventional biometric sensors are also susceptible to temperature variations, air pressure, and humidity. Environmental conditions such as humidity and temperature also affect finger conditions such as skin moisture. These changes lead to problems like variations in the sensor's resonant frequency and sensor accuracy, thus degrading sensor performance. This degradation can lead to changes in signal level and bias of the sensor's output that are unmitigated by conventional processing circuits. Changes in signal level cause the signal level to become too weak, also known as washed-out, or too strong, which is known as binarized. Both of these problems result in a loss of information.

Conventional biometric sensors also suffer from manufacturing variations. Manufacture of piezoelectric sensors requires cutting and grinding of crystals that form an array of pillars. The cutting and grinding varies crystal pillar length from sensor to sensor, affecting response of the crystal to finger pressure and thus sensor performance. These variations also make each sensor unique, resulting in each sensor having a slightly different resonant frequency. These variations in resonant frequency degrade sensor performance and lead to changes in signal level and bias of the sensor's output that are unmitigated by conventional processing circuits.

As noted above, the output of conventional biometric sensors can also be affected by finger conditions. For example, the valley-to-ridge ratio varies from person to person. This results in variation from person to person in a ratio of dark-to-light pixels, and thus contrast, in the captured image. Moisture content of skin of the finger can also affect sensor performance. In dry air, such as that found in winter or an air-conditioned environment, a finger tends to have less moisture. In hot, moist air, the finger sweats, resulting in a darker image, relative to that of a dry finger. Conversely, a dry finger produces a lighter image than that of a wet finger. Other finger conditions, such as dirt in fingerprint valleys also has an effect on biometric sensor performance. A dirty finger produces the same image problems as those produced by a wet finger. These variations in finger conditions degrade sensor performance and lead to changes in signal level and bias of the sensor's output that are unmitigated by conventional processing circuits.

Conventional biometric sensors, and their processing circuits, also fail to automatically detect placement of a finger on a biometric sensor. Similarly, these conventional biometric sensor arrangements also fail to automatically detect removal of the finger from the biometric sensor. Lack of automatic finger detection leads to an excessive number of processing steps and excessively slow sensor performance.

What is needed, therefore, is a biometric sensor optimization technique that reduces the effects of the environment, manufacturing variations, and finger conditions as noted above in conventional approaches.

### SUMMARY OF THE INVENTION

The present invention is directed to a method for dynamic optimization of a biometric sensor. The method includes receiving image data having pixel values. The pixel values are processed to determine a bias. An offset adjustment is determined to mitigate the bias. The biometric sensor is adjusted with the offset adjustment.

Further embodiments, features, and advantages of the present invention, as well as the structure and operation of the various embodiments of the present invention are described in detail below with reference to accompanying drawings.

### BRIEF DESCRIPTION OF THE DRAWINGS/FIGURES

The accompanying drawings illustrate the present invention and, together with the description, further serve to explain the principles of the invention and to enable one skilled in the pertinent art to make and use the invention.

FIG. 1 is an illustration of a biometric sensing device.

FIG. 2 is an illustration of image data produced by a swipe-style piezoelectric sensor.

FIG. 3 is a graphical illustration of noise signal image data.

FIG. 4 is a graphical illustration of noise signal image data having a positive bias.

FIG. 5 is a graphical illustration of noise signal image data having a negative bias.

FIG. 6 is a flowchart of an exemplary method for adjusting offset of a biometric sensor in accordance with a first embodiment of the present invention.

FIG. 7 is a graphical illustration of noise signal low amplitude image data.

FIG. 8 is a graphical illustration of noise signal high amplitude image data.

FIG. 9 is a flowchart of an exemplary method for adjusting offset of a biometric sensor in accordance with a second embodiment of the present invention.

FIG. 10 is a graphical illustration of dynamic use of a histogram applied to a noise signal to detect image data clipping in accordance with the present invention.

FIG. 11 is a graphical illustration of a noise signal of a disproportionably high pixel count in a high end bin that is present when image data has a positive bias.

FIG. 12 is an exemplary flowchart of a method for adjusting offset of a biometric sensor in accordance with a first embodiment of the present invention.

FIG. 13 is a block diagram illustration of an exemplary computer system upon which the present invention can be implemented.

In the drawings, like reference numbers generally indicate identical, functionally similar, and/or structurally similar elements. The drawing in which an element first appears is usually indicated by the leftmost digit(s) in the reference number.

### DETAILED DESCRIPTION OF THE INVENTION

This specification discloses one or more embodiments that incorporate the features of this invention. The embodiment(s) described, and references in the specification to “one embodiment”, “an embodiment”, “an example embodiment”, etc., indicate that the embodiment(s) described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the art to effect such feature, structure, or characteristic in connection with other embodiments whether or not explicitly described.

### Overview

Embodiments provide methods, apparatus, and computer program products for dynamic optimization of a biometric sensor. Dynamic optimization mitigates problems caused by environmental conditions, manufacturing variations, and finger conditions. In a further example, a method, apparatus, and computer program product automatically detects placement of a finger on a biometric sensor.

A biometric sensor, such as a piezoelectric touch sensor, has two primary mechanisms for adjustment, gain and offset. Offset compensates bias present in image data provided by the biometric sensor. Gain compensates variations in signal strength of the image data. Dynamic optimization detects problems with bias and signal level by analyzing pixel values in the image data. The problems are detected by determining if pixel values in the image data have are equal to, or in excess of, an upper or a lower limit. Dynamic optimization can use a histogram of the image data to assist in its determination. Dynamic optimization then alters the offset adjustment to mitigate problems with bias, and alters the gain adjustment to mitigate problems with signal strength. The corrections are made between each scan of the biometric sensor.

### Exemplary Apparatus

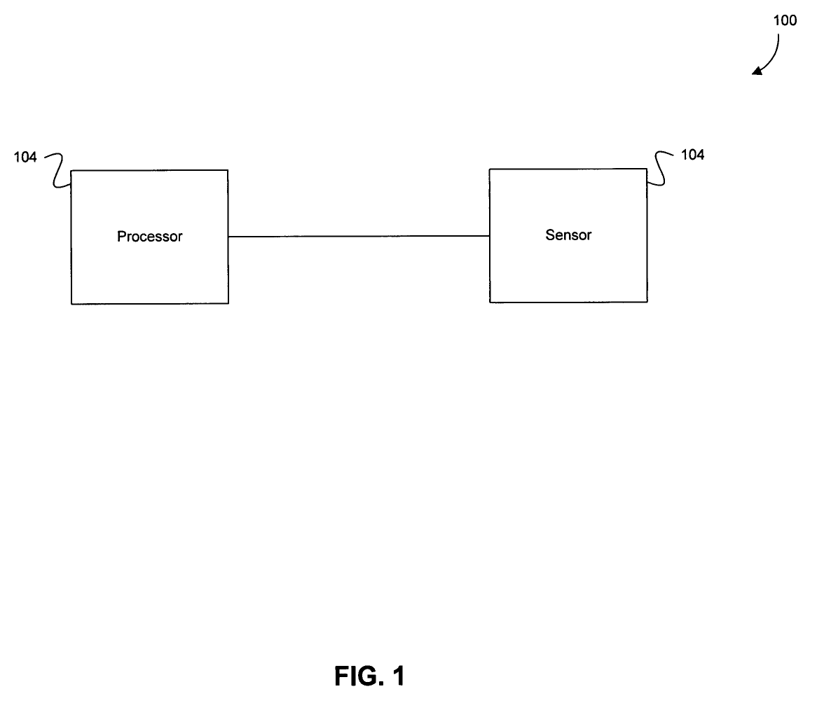

FIG. 1 is an illustration of an exemplary biometric sensing device 100. In FIG. 1, the biometric sensing device 100 includes a sensor 102 for obtaining biometric data (e.g. fingerprint data). The sensor 102 can be, for example, an acoustic impediography-type device or a piezoelectric device. The sensor 102, however, is not limited to these types of sensors. Other types of sensors can be used in the biometric sensing device 100. The sensor 102 captures at least a partial image of a sampled biometric feature, such as a fingerprint. The sensor 102 is coupled to a processor 104. The processor 104 executes a method as described herein. At least a part of the apparatus described herein can be deposited on a substrate.

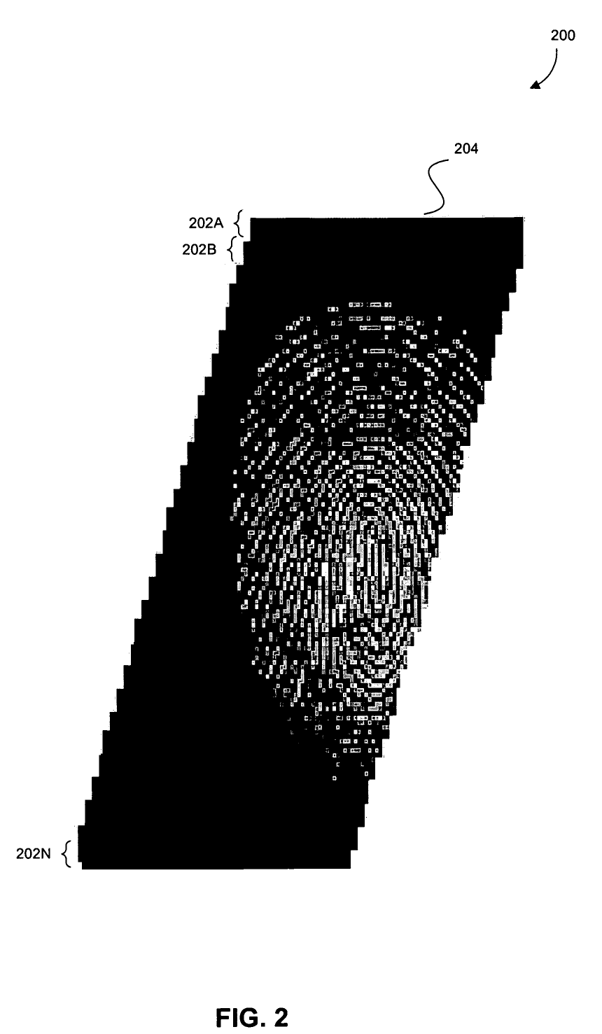

FIG. 2 is an illustration of exemplary image data 200 produced when the sensor 102 is a swipe-style piezoelectric sensor. When sampling a feature, the sensor 102 of FIG. 1 can generate an exemplary series of partial images 202A, B, . . . , N, where N is a positive integer. The sensor 102 performs a scan to produce each of the partial images 202A, B, . . . , N. As used herein, each scan can also be referred to as a slice. Each of the partial images 202A, B, . . . , N contains a plurality of pixels. Each pixel has a pixel value 204.

### Image Bias

Bias in the image data 200 manifests itself as an image being “too white” or “too dark.” This bias results in “clipping” of the image data 200 at a minimum or a maximum value, which causes both a detrimental reduction in dynamic range of the image data 200 and a loss of information in the image data 200. For example, a piezoelectric sensor provides 8-bit pixel values 204 in the image data 200. Thus, the corresponding pixel values 204 will range from zero to 255. If the bias is toward a top of this range, the pixel values 204 will be skewed in the direction of 255 and limited to a maximum value of 255. On the other hand, if the bias is toward a bottom of this range, the pixel values 204 will be skewed in the direction of zero and limited to a minimum value of zero. In short, the bias causes a loss of information in the image data 200.

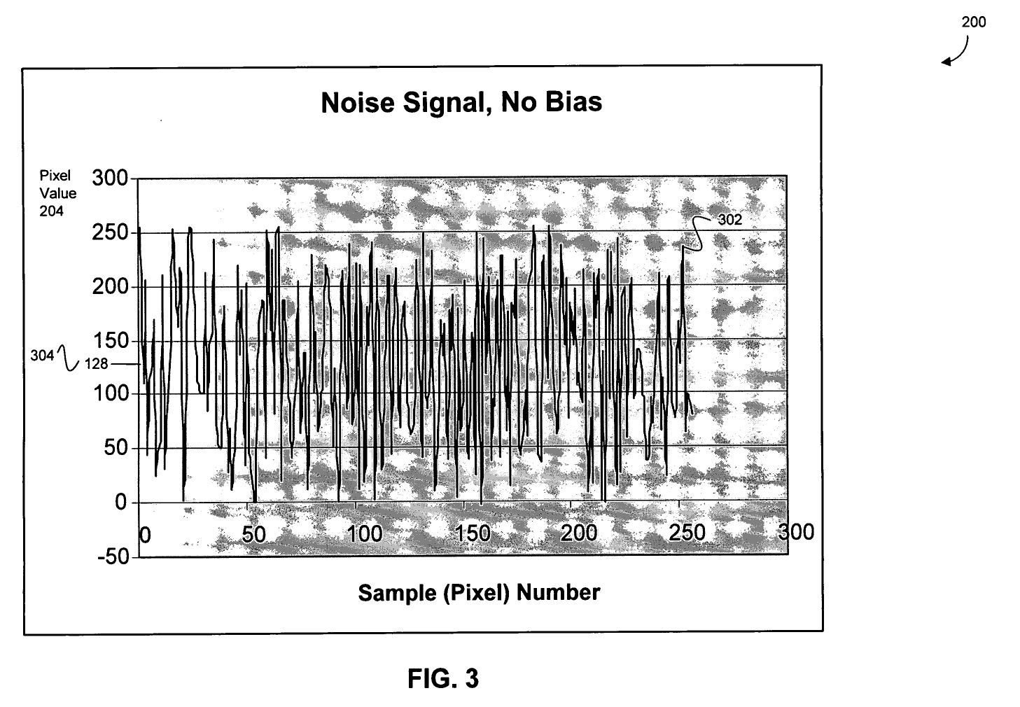

Dynamic optimization mitigates the effects of the bias by adjusting the sensor 102 with an offset. The offset centers an average pixel value 204 of the image data 200 at substantially half-way between the minimum and maximum pixel values 204, such as the average pixel value of 128 that is half-way between the minimum pixel value of zero and the maximum pixel value of 255. An example of mitigating the bias follows in FIGS. 3 through 6.

FIG. 3 is an illustration of the image data 200 in the form of an exemplary noise signal 302 having a range of pixel values 204 from zero to 255, and centered at a particular pixel value 304 of 128. In FIG. 3, the noise signal 302 has essentially no bias. That is, the average pixel value over time is substantially centered on a value half-way between the minimum and maximum pixel values 204. Although additional pixels will usually be present in an actual noise signal, in the noise signal 302 of FIG. 3, only 256 pixels are shown for purposes of convenience. A slice from the sensor 102 can have a different number of pixels than 256. In other words, a slice is not limited to 256 pixels.

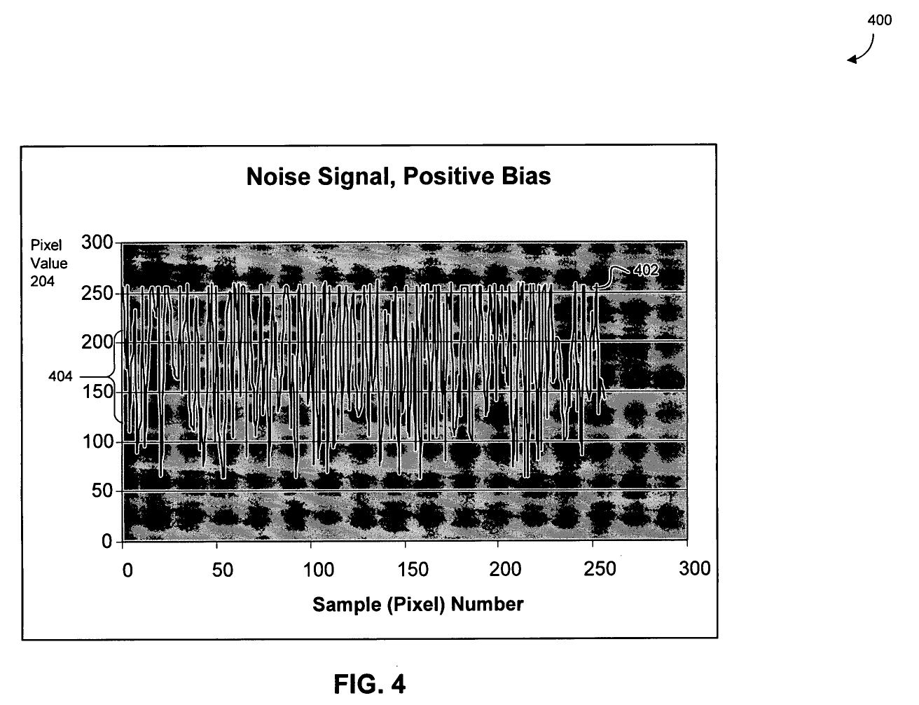

FIG. 4 is an illustration of image data 400 in the form of an exemplary noise signal 402 having a positive bias 404. That is, in the noise signal 402, the average pixel value over time is substantially centered higher than a value half-way between the minimum and maximum pixel values 204. In FIG. 4, there are a significant number of pixels that are clipped by the maximum pixel value of 255. Conversely, the image data 200 contains few or no pixels having the minimum pixel value of zero. As a result, the positive bias 402 reduces a dynamic range of the sensor 102 by clipping the pixel values 204 in the direction of the maximum value of 255.

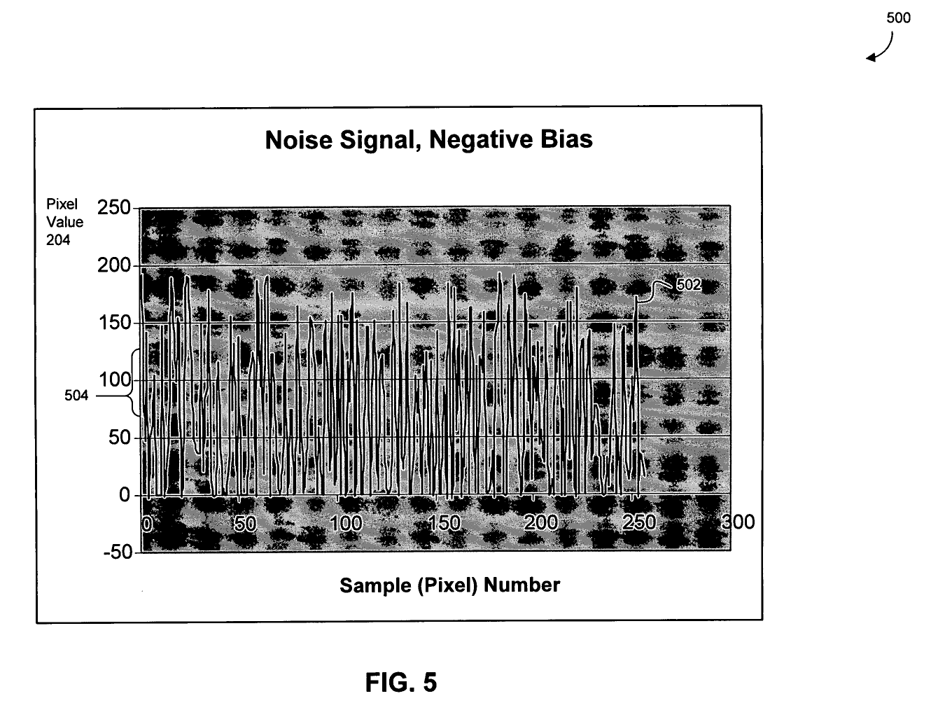

Conversely, FIG. 5 is an illustration that shows an example of image data 500 in the form of an exemplary noise signal 502 having a negative bias 504. A positive bias 402 and a negative bias 502 are determined relative to a pixel value 204 that is approximately a mean of the range of pixel values 204. In the example of FIGS. 3 through 6, the mean is 128. Thus, when the pixel values 204 of the image data 200 have an average value greater than 128, the positive bias 402 is present in the image data 200. Conversely, when the pixel values 204 of the image data 200 have an average value that is less than 128, the negative bias 502 is present in the image data 200.

In FIG. 5, the bias is negative, the pixel values 204 are clipped by the minimum pixel value 204 of zero. The maximum pixel value 204 of 255 has few or no pixels. Similar to the positive bias 402, the negative bias 502 also reduces the dynamic range of the sensor 102 by clipping the pixel values 204 in the direction of the minimum value of zero.

To compensate for either the positive bias 402 or the negative bias 502, the sensor 102 is adjusted with the offset to substantially center the average pixel value of the image data 200 within the pixel value 204 range of zero to 255. The sensor 102 can be adjusted dynamically in a time between a first scan by the sensor 102 and a second scan by the sensor 102.

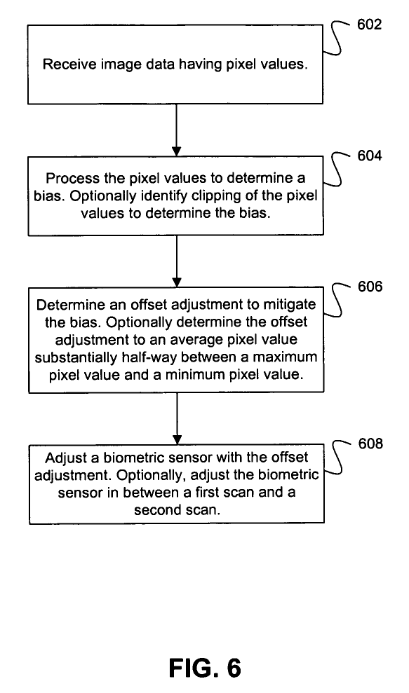

FIG. 6 is an illustration of an exemplary method 600 for adjusting offset of the biometric sensor 102. In step 602, the image data 200 having pixel values 204, is received as an input to the sensor 102. The image data 200 can be produced by with a single slice of the biometric sensor 102. In step 604, the pixel values 204 are processed to determine the presence of any bias. A bias determination can be made based upon the presence of clipping.

In step 606, an offset adjustment determination is made to mitigate the bias. The actual amount of the offset adjustment can be related to an average pixel value 204 (i.e., substantially half-way between a maximum pixel value 204 and a minimum pixel value 204). The effect of the offset can be such that a total response of the method 600 is dampened. In step 608, the biometric sensor is adjusted with the offset adjustment. As a practical matter, the biometric sensor can be dynamically adjusted between a first scan and a second scan.

### Image Signal Level

As noted above, an improper signal level of the image data 200 manifests itself as an image being too high or too low in contrast. A signal level that is too high appears binarized. Conversely, a signal level that is too low appears washed-out. The improper signal level results in either (1) clipping of the pixel values 204 at both the minimum and maximum values or (2) the image data 200 containing few or no pixel values 204 at the maximum and minimum values. Thus, by way of review, an improper signal level creates a loss of information in the image data 200.

Dynamic optimization, implemented in accordance with the present invention, mitigates the improper signal level by adjusting the gain of the sensor 102. This gain adjustment maximizes the range of pixel values 204 contained in the image data 200, without a substantial loss of information in the image data 200. An example of mitigating the improper signal level follows in FIGS. 3 and 7-9.

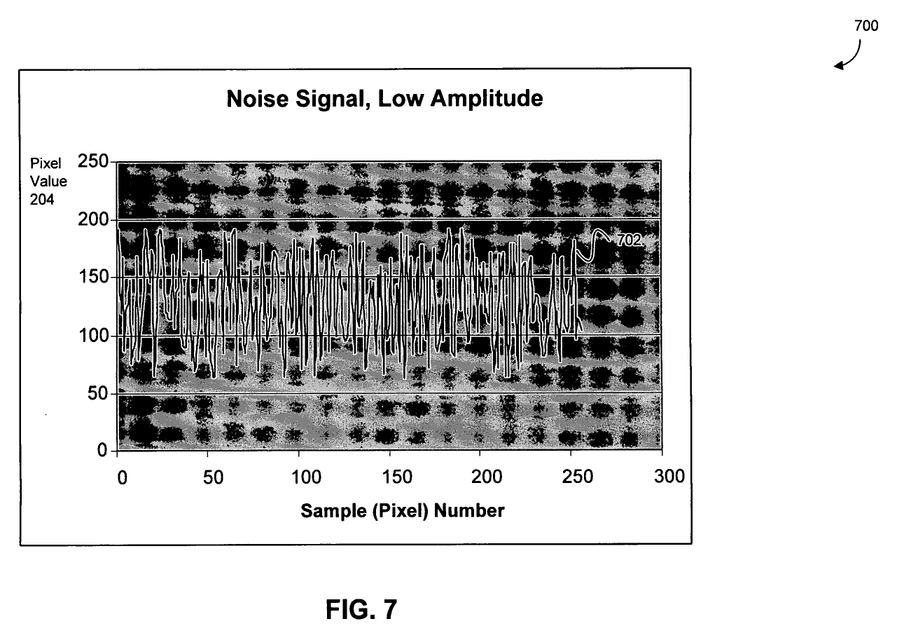

FIG. 7 is a graphical exemplary illustration 700 of a noise signal including low amplitude image data 702. The low amplitude image data 702 contains few or no pixel values 204 at the maximum and the minimum pixel values. Thus, information is lost because the range of pixel values 204 that is available for use are not used by the low amplitude image data 702. Continuing with this example, the entire range of pixel values 204, zero to 255, are not used by the low amplitude image data 702.

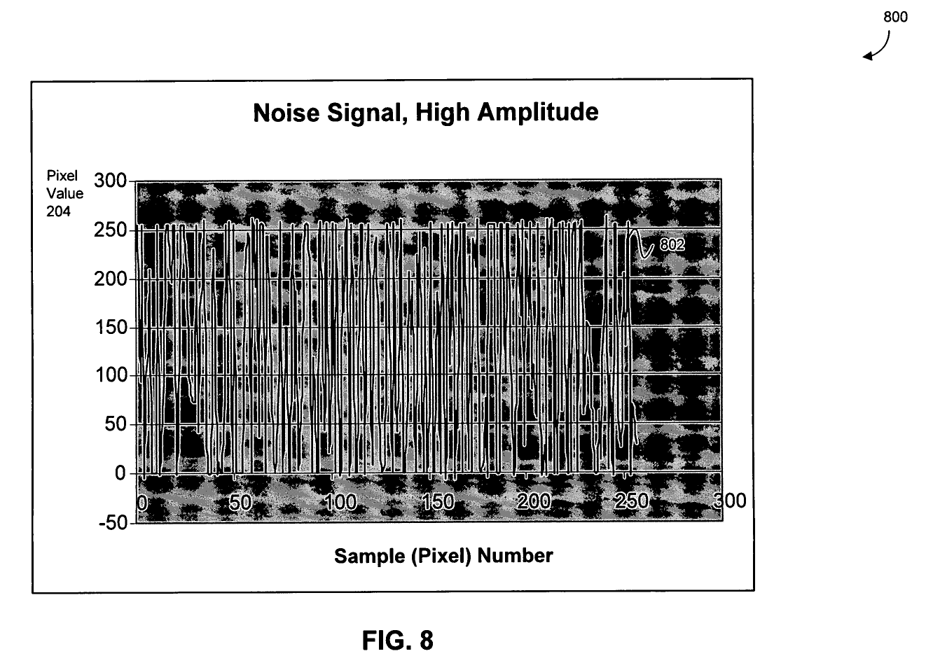

FIG. 8 is a graphical illustration 800 of a noise signal including high amplitude image data 802. The high amplitude image data 802 is clipped at both the maximum and minimum pixel values. In an example, the high amplitude image data 802 contains more maximum and minimum pixel values than intermediate pixel values. Thus, in this case, information is lost because too many pixel values 204 in the high amplitude image data 802 have values that are skewed to the maximum and minimum pixel values.

To compensate for an improper signal level, dynamic optimization makes a gain adjustment to the sensor 102 to more equally distribute the pixel values 204 in the low amplitude image data 702 or the high amplitude image data 802. The sensor 102 can be adjusted dynamically in the time between the first scan by the sensor 102 and the second scan by the sensor 102. FIG. 3 is an illustration of exemplary image data 200 after application of such a gain adjustment. Note that in FIG. 3, there is substantially no bias and substantially full gain.

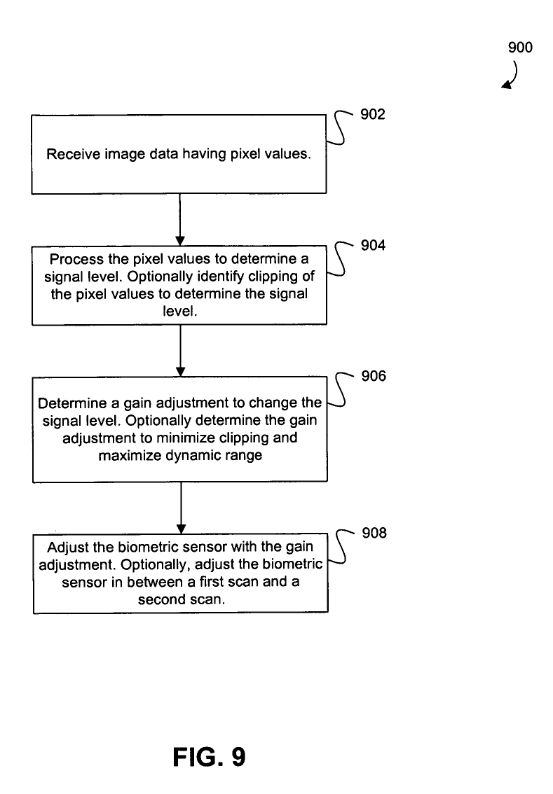

FIG. 9 is a flowchart of an exemplary method 900 for adjusting offset of a biometric sensor 102 in accordance with the present invention. In step 902, image data 200 having pixel values 204 is received. The image data 200 can be from a single scan from the biometric sensor 102. In step 904, the pixel values 204 are processed to determine their signal level, which can be accomplished based on the presence of clipping or through use of a histogram. In step 906, the amount of gain to be applied to the sensor in order to change the signal level is determined. This gain adjustment can also be used to maximize the sensor's dynamic range. In step 908, the gain adjustment is applied to the sensor. As a practical matter, the gain adjustment can be applied to the sensor dynamically, for example, between a first scan and a second scan.

### Dynamic Optimization of a Biometric Sensor

As discussed above, the gain and offset adjustments can be optimized dynamically. By way of example, the gain and offset adjustments can be performed after the first scan by the sensor 102. The inventor's dynamic optimization technique enables processing of the pixel values 204 solely on the basis of detecting clipping in the image data 200. That is, after the image data 200 is received, the pixel values 204 are examined to detect clipping at either the maximum or the minimum pixel values. The dynamic optimization technique is configured to detect a relatively large number of pixels at either the maximum pixel value or the minimum pixel value 204 in the range of pixel values.

In an example, a percentage of pixel values 204 at the minimum pixel value and/or the maximum pixel value are compared to a user-established threshold value or through use of histogramming, as described more fully below. Other methods to detect clipping can also be used. Continuing with the example above, dynamic optimization facilitates detection of a relatively large number of pixels having the pixel value 204 of zero or the pixel value 204 of 255. This detection is also described herein as “detecting an upper limit” and/or “detecting a lower limit.” Gain and offset adjustments are then determined from the results of this process.

If neither the maximum pixel value (i.e., 255) nor the minimum pixel value (i.e., zero) is detected over time, the signal level is too low. If the signal level is found to be too low, an adjustment to increase the gain is provided to the sensor 102. On the other hand, if both the maximum pixel value and the minimum pixel value are detected too often over time, the signal level is too high. If the signal level is found to be too high, an adjustment to decrease the gain is provided to the sensor 102.

If, over time, the maximum pixel value is detected, but the minimum pixel value isn't detected, the image data 200 has a positive bias 402. To mitigate the effects of this positive bias, an offset adjustment to decrease the bias is provided to the sensor 102. If, over time, the minimum pixel value is detected, but the maximum pixel value isn't, the image data 200 has a negative bias 502. To mitigate the effects of this negative bias, an offset adjustment to increase bias is provided to the sensor 102. Table 1 summarizes these adjustments:

TABLE 1

| | Upper Limit not | Upper Limit |
|---|---|---|
| | Detected | Detected |
| Low Limit not | Increase Gain | Decrease Offset |
| Detected | | |
| Low Limit Detected | Increase Offset | Decrease Gain |

The magnitude of any adjustments to the gain, or offset, can be estimated from the image data 200 and can be applied incrementally. In addition, the magnitude of these gain adjustments can be configured such that a total response of the system is dampened so that the system is stable.

### Using Histograms to Detect Clipping

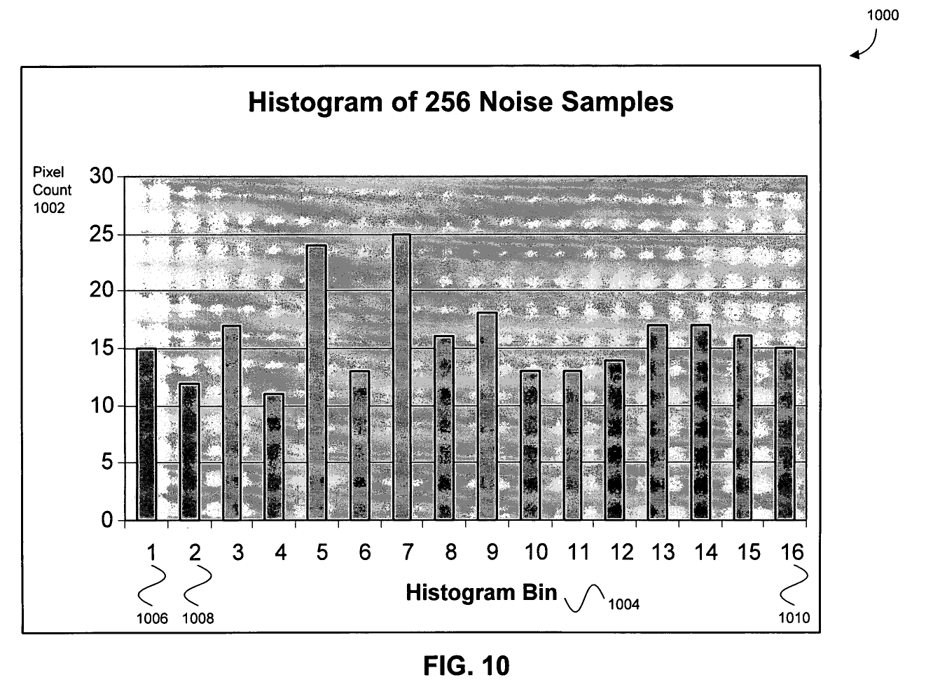

FIG. 10 is a graphical illustration of dynamic use of a histogram applied to a noise signal to detect image data clipping in accordance with the present invention. As shown in FIG. 10, a histogram 1000 is used to detect clipping of the image data 200. The histogram 1000 consists of pixel counts 1002 of how many pixels having certain pixel values 204 fall in a certain range, or bin 1004. For example, a histogram having 256 bins can show how many pixels, or a percentage of pixels, there are of each possible pixel value from “zero” to “255” in the image data 200. In a 16-bin histogram, such as the example of FIG. 10, a bin 1004 represents a range of 16 pixel values. In this example, a first bin, also known as a low end bin 1006, represents the pixel count 1002 in the image data 200 having values of 0-15 (inclusive). A second bin 1008 represents the pixel count 1002 in the image data 200 having values of 16-31 (inclusive), etc. . . . The low end bin 1006 contains the lowest possible pixel value. A high end bin 1010 contains pixels having the highest possible pixel values.

Referring back to FIG. 3, exemplary image data 200 of the noise signal 302 has substantially no offset and enough gain to cover the full range of pixel values 204. The noise sample 302 contains 256 samples.

FIG. 10 is an illustration that further shows 15 of the 256 samples have a value of 0-15 in the low end bin 1006. The total pixel count of from all bins in the 16-bin histogram 1000 adds up to substantially equal the total number of samples. In this example, the total number of samples is 256.

When either of the end bins has a substantial pixel count, an upper and/or lower limit condition is detected. A pixel count for a bin can be determined to be substantial if the pixel count meets and/or exceeds a threshold value. For example, FIG. 4 is an illustration of image data 400 having a positive bias 402.

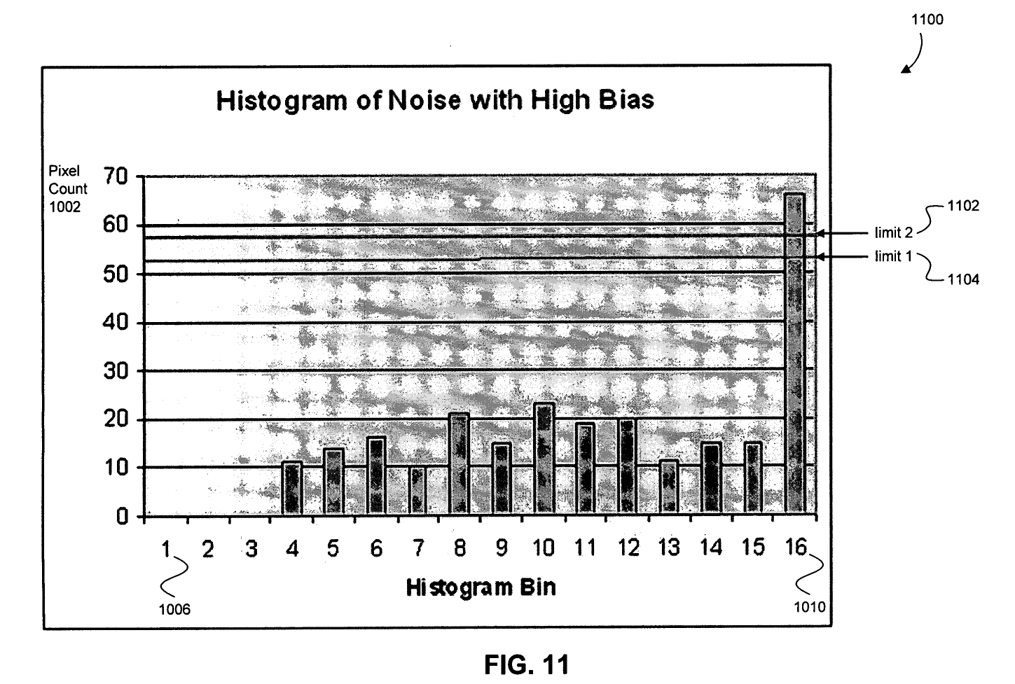

FIG. 11 is an illustration of a 16-bin histogram 1100 of the image data 400 having the positive bias 402 from FIG. 4. As illustrated in FIG. 11, when the image data 400 has a positive bias 402, the high end bin 1010 has a disproportionably high pixel count 1002. Conversely, the low end bin 1006 has a disproportionably low pixel count 1002. This disproportion indicates a presence of the positive bias 402 and represents detection of an upper limit. Conversely, when the high end bin 1010 has a disproportionably low pixel count 1002 and the low end bin 1006 has a disproportionably high pixel count 1002, this disproportion indicates a presence of a negative bias 502 and detection of a lower limit.

The histogram 1000 (see for example, FIG. 10) can also be used to detect an improper signal level. If the signal level is too high, then both the high end bin 1010 and the low end bin 1006 will contain disproportionably high pixel counts 1002 relative to the pixel count 1002 in a bin in the middle of the histogram. If the signal level is too low, then both the high end bin 1010 and the low end bin 1006 will contain disproportionably low pixel counts 1002 relative to the pixel count 1002 in a bin in the middle of the histogram.

FIG. 11 is an illustration that further shows the total response of the methods described herein can be dampened. This dampening is facilitated by using a rising threshold (limit2) 1102 and a falling threshold (limit1) 1104 for detection of both the maximum pixel value in the high end bin 101 and the minimum pixel value in the low end bin 1006. For example, the rising threshold (limit2) 1102 is higher than the falling threshold (limit1) 1104 for the high end bin 1010. Thus, the sensor 102 is adjusted only when the pixel count 1002 of the high end bin 1010 exceeds the rising threshold (limit2) 1102. Sensor adjustment stops only when the pixel count 1002 in the high end bin 1010 decreases below the falling threshold (limit1) 1104. A similar arrangement can be implemented for the low end bin 1006. The limits, number of bins, and pixel counts illustrated in FIG. 11 are for illustration only, and other limits, number of bins, and pixel counts 1002 can be used. When dampened, the adjustments illustrated in Table 1 take a form as illustrated in Table 2, below:

TABLE 2

| | Black | |
|---|---|---|
| | percentage < | Black percentage > |
| | UpperLimit1 | UpperLimit2 |
| White Percentage < LowerLimit1 | Increase Gain | Decrease Offset |
| White Percentage > LowerLimit2 | Increase Offset | Decrease Gain |

### Detecting Change of Presence of an Input

Processing of the image data 200 can also detect a change in presence of an input to a the biometric sensor 102, for example, placement of a digit (e.g., a finger) on a fingerprint sensor. When there is no finger on the sensor, the sensor 102 produces image data 200 requiring maximum gain. When a finger is placed on the sensor 102, both the upper and the lower limits are detected in the rapidly-changing image data 200, resulting in the gain being decreased to the point where the upper and the lower limits are no longer achieved. In an example, an absolute difference in gain between a first and a second scan can be compared to a reference value to determine a rate of change in the gain adjustment. In a further example, the first and second scans are consecutive.

A rapid change of gain can represent the placement of a finger on the sensor 102. When the histogram 1000 is used, this finger placement results in both the high end bin 1010 and the low end bin 1006 having a relatively high pixel count 1002. This effect occurs because ridges and valleys of the fingerprint produce image data 200 having pixel values 204 predominately in both the high end bin 1010 and the low end bin 1006. Analyzing the high end bin and low end bin will result in gain being reduced slightly less than a maximum gain adjustment. This gain reduction is a change that indicates the presence of a finger. Once the finger is detected, a different threshold for detecting upper and lower limits can be used. In other words, the value of the rising threshold (limit2) 1102 and the falling threshold (limit1)1104 can change.

Conversely, after the presence of a finger is detected on the sensor 102, an increase in gain can occur, representing that the finger has been removed from the sensor 102.

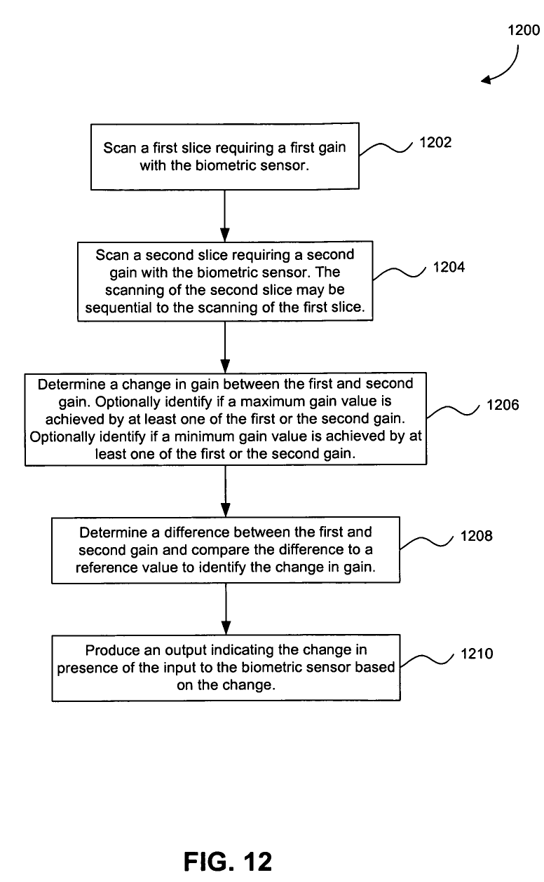

FIG. 12 is an exemplary method 1200 for adjusting offset of a biometric sensor 102. In step 1202, a first slice requiring a first gain is scanned with the biometric sensor 102. The first slice can contain first pixel values 204. In step 1204, a second slice requiring a second gain is scanned with the biometric sensor 102. The second slice can contain second pixel values. The scanning of the second slice can be sequential to the scanning of the first slice.

In step 1206, a determination is made as to whether there is a change in gain values between the first and second gain. Optionally, a maximum gain value is identified as being achieved by at least one of the first or the second gain. A minimum gain value can also be identified as being achieved by at least one of the first or the second gain. A first histogram can be produced having bins containing the first pixel values. A number of pixels in an end bin of the first histogram can be compared to a first threshold value to determine if an upper or lower limit is met. A second histogram can be produced having bins containing the second pixel values. A number of pixels in an end bin of the second histogram can be compared to a second threshold value to determine if an upper or lower limit is met. The first and second threshold values can or cannot be identical.

In step 1208, a difference between the first and second gain is determined. Any difference is compared to a reference value to identify the change in gain. A change in gain signal can be output if the upper or the lower limit for the first histogram is met and if the upper or the lower limit for the second histogram is met.

In step 1210, an output indicating the change in presence of the input to the biometric sensor based on the change is produced.

The methods and/or processes herein (i.e., the system and/or process listed above or any part(s) or function(s) thereof) can be implemented using hardware, software or a combination thereof and can be implemented in one or more computer systems or other processing systems. However, the manipulations performed by the present invention were often referred to in terms, such as adding or comparing, which are commonly associated with mental operations performed by a human operator. No such capability of a human operator is necessary, or desirable in most cases, in any of the operations described herein which form part of the present invention. Rather, the operations are machine operations. Useful machines for performing the operation of the present invention include general purpose digital computers and/or similar devices.

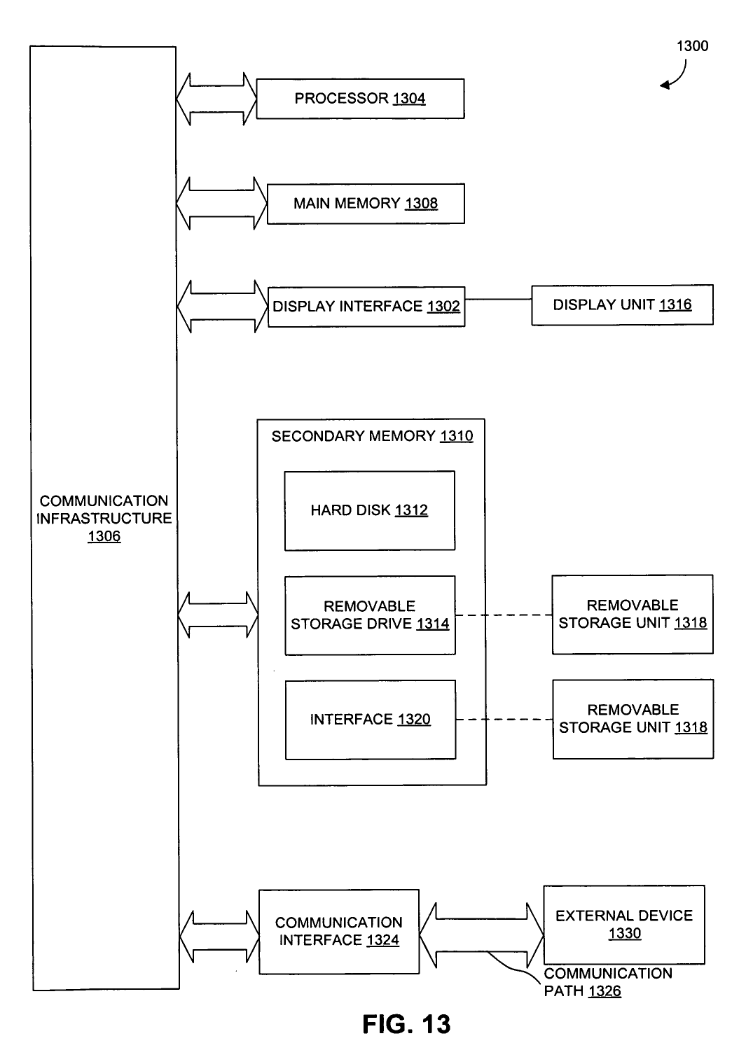

In one embodiment, the invention is directed toward one or more computer systems capable of carrying out the functionality described herein. An example of a computer system 1300 is shown in FIG. 13.

The computer system 1300 includes the processor 1304, such as the processor 104. The processor 1304 is coupled to a communication infrastructure 1306 (e.g., a communications bus, cross-over bar, or network). Various software embodiments are described in terms of this exemplary computer system. After reading this description, it will become apparent to a person skilled in the relevant art(s) how to implement the invention using other computer systems and/or architectures.

The computer system 1300 can include a display interface 1302 that forwards graphics, text, and other data from the communication infrastructure 1306 (or from a frame buffer not shown) for display on a display unit 1316.

The computer system 1300 also includes a main memory 1308, preferably random access memory (RAM), and can also include a secondary memory 1310. The secondary memory 1310 can include, for example, a hard disk drive 1312 and/or a removable storage drive 1314, representing a floppy disk drive, a magnetic tape drive, an optical disk drive, an information storage device, etc. The removable storage drive 1314 reads from and/or writes to a removable storage unit 1318. The removable storage unit 1318 represents a floppy disk, a magnetic tape, an optical disk, etc. which is read by, and written to, by the removable storage drive 1314. The removable storage unit 1318 includes a computer usable storage medium having stored therein computer software and/or data.

In alternative embodiments, the secondary memory 1310 can include other similar devices for allowing computer programs or other instructions to be loaded into the computer system 1300. Such devices can include, for example, the removable storage unit 1318 and an interface 1320. Examples of the secondary memory 1310 include a program cartridge and cartridge interface, a removable memory chip (such as an erasable programmable read only memory (EPROM), and/or programmable read only memory (PROM)) with an associated socket, and the removable storage unit 1318 and/or the interface 1320, which allow software and data to be transferred from the removable storage unit 1318 to the computer system 1300.

The computer system 1300 can also include a communications interface 1324. The communications interface 1324 allows software and data to be transferred between the computer system 1300 and an external device 1330. Examples of the communications interface 1324 can include a modem, a network interface (such as an Ethernet card), a communications port, a Personal Computer Memory Card International Association (PCMCIA) slot and card, etc. Software, data, and processor instructions transferred via the communications interface 1324 can be in a form of signals which can be electronic, electromagnetic, optical or other signals capable of being received by the communications interface 1324. The signals are provided to the communications interface 1324 via a communications path (e.g., channel) 1326. The communications path 1326 carries signals and can be implemented using wire or cable, fiber optics, a telephone line, a cellular link, a radio frequency (RF) link, and/or other communications channels.

In this document, the terms “computer program medium” and “computer usable medium” are used to generally refer to media such as the removable storage drive 1314, a hard disk installed in the hard disk drive 1312, and signals. These computer program products provide software to the computer system 1300. The invention is directed to such computer program products.

Computer programs (also referred to as computer control logic) are stored in the main memory 1308 and/or the secondary memory 1310. The computer programs can also be received via the communications interface 1324. Such computer programs, when executed, enable the computer system 1300 to perform the features of the present invention, as discussed herein. In particular, the computer programs, when executed, enable the processor 1304 to perform the features of the present invention. Accordingly, such computer programs represent controllers of the computer system 1300.

In an embodiment where the invention is implemented using software, the software can be stored in a computer program product and loaded into the computer system 1300 using the removable storage drive 1314, the hard drive 1312 or the communications interface 1324. The control logic (software), when executed by the processor 1304, causes the processor 104 to perform the functions of the invention as described herein.

In another embodiment, the invention is implemented primarily in hardware using, for example, hardware components such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

### Conclusion

Examples that incorporate the features of this invention are described herein. These examples are described for illustrative purposes only, and are not limiting. Other embodiments are possible. Such other embodiments will be apparent to persons skilled in the relevant art(s) based on the teachings contained herein. Thus, the breadth and scope of the present invention is not limited by any of the above-described exemplary embodiments, but must be defined only in accordance with the following claims and their equivalents.

The description fully reveals the nature of the invention that others may, by applying knowledge within the skill of the art, readily modify and/or adapt for various applications the exemplary embodiments, without undue experimentation, and without departing from the general concept of the present invention. Therefore, such adaptations and modifications are intended to be within the meaning and range of equivalents of the disclosed embodiments, based on the teaching and guidance presented herein. It is to be understood that phraseology and terminology herein is for the purpose of description and not for limitation, such that the terminology and phraseology of the present specification is to be interpreted by the skilled artisan in light of the teachings and guidance herein.

What we claim is:

1. A method for adjusting offset of a biometric sensor, comprising:
receiving image data having pixel values;
processing the pixel values to determine a bias;
determining an offset adjustment to mitigate the bias; and
adjusting the biometric sensor with the offset adjustment.

2. The method of claim 1, wherein the receiving comprises using image data from a single scan from the biometric sensor.

3. The method of claim 1, wherein the processing further comprises identifying clipping of the pixel values to determine the bias.

4. The method of claim 1, wherein the determining comprises determining the offset adjustment to center an average pixel value substantially half-way between a maximum and a minimum pixel value.

5. The method of claim 1, further comprising:
scanning a single slice with the biometric sensor to produce the image data.

6. The method of claim 1, wherein the adjusting further comprises adjusting the biometric sensor between a first scan of a single slice and a second scan of a single slice with the biometric sensor.

7. The method of claim 1, wherein the determining comprises determining the offset adjustment such that a total response of the method is dampened.

8. A method for adjusting gain of a biometric sensor, comprising:
receiving image data having pixel values;
processing the pixel values to determine a signal level;
determining a gain adjustment to change the signal level; and
adjusting the biometric sensor with the gain adjustment.

9. The method of claim 8, wherein the receiving comprises using image data from a single scan from the biometric sensor.

10. The method of claim 8, wherein the determining comprises determining a gain adjustment to minimize clipping and maximize dynamic range.

11. The method of claim 8, wherein the processing further comprises identifying clipping of the pixel values to determine the signal level.

12. The method of claim 8, further comprising:
scanning a single slice with the biometric sensor to produce the image data.

13. The method of claim 8, wherein the adjusting further comprises adjusting the biometric sensor between a first scan of a single slice and a second scan of a single slice with the biometric sensor.

14. The method of claim 8, wherein the determining comprises determining the gain adjustment such that a total response of the method is dampened.

15. A method for detecting a change in presence of an input to a biometric sensor, comprising:
scanning a first slice requiring a first gain with the biometric sensor;
scanning a second slice requiring a second gain with the biometric sensor;
determining a change in gain between the first and second gain; and
producing an output indicating the change in presence of the input to the biometric sensor based on the change.

16. The method of claim 15, wherein the determining further comprises identifying if a maximum gain value is achieved by at least one of the first or the second gain.

17. The method of claim 15, wherein the determining further comprises identifying if a minimum gain value is achieved by at least one of the first or the second gain.

18. The method of claim 15, wherein the determining further comprises
determining a difference between the first and second gain; and
comparing the difference to a reference value to identify the change in gain.

19. The method of claim 15, wherein the method further comprises:
receiving first pixel values from the first slice;
receiving second pixel values from the second slice;
producing a first histogram having bins containing the first pixel values;
comparing a number of pixels in an end bin of the first histogram to a first threshold value to determine if an upper or lower limit is met;
producing a second histogram having bins containing the second pixel values;
comparing a number of pixels in an end bin of the second histogram to a second threshold value to determine if an upper or lower limit is met; and
outputting a change in gain signal if the upper or the lower limit for the first histogram is met and if the upper or the lower limit for the second histogram is met.

20. The method of claim 15, wherein the scanning the second slice is sequential to the scanning the first slice.
